(19) United States
(12) Patent Application Publication
(10) Pub. No.: US 2013/0223047 A1
(43) Pub. Date: Aug. 29, 2013

(54) GLASS LED LIGHT BULBS

(71) Applicant: SWITCH BULB COMPANY, INC., (US)

(72) Inventors: Ronald J. LENK, Woodstock, GA (US); Jonathan BETTS-LACROIX, San Francisco, CA (US)

(73) Assignee: SWITCH BULB COMPANY, INC., San Jose, CA (US)

(21) Appl. No.: 13/863,334

(22) Filed: Apr. 15, 2013

Related U.S. Application Data
(63) Continuation of application No. 12/681,774, filed on Jul. 14, 2010, now Pat. No. 8,439,528.
(60) Provisional application No. 60/977,144, filed on Oct. 3, 2007.

(51) Int. Cl. F21V 3/04

(52) U.S. Cl. CPC F21V 3/049; F21V 3/0409
USPC 362/157; 362/363; 362/311.02

(57) ABSTRACT

A glass LED bulb, which includes a body of glass, the body having at least one hollow portion, and at least one LED contained within the at least one hollow portion. A thermally conductive material is preferably included within the at least one hollow portion. The body of glass can be bulb-shaped or alternatively shaped like an incandescent bulb.

### FIELD OF THE INVENTION

The present invention relates to replacement of bulbs used for lighting by light emitting diode (LED) bulbs, and more particularly, to the efficient removal of the heat generated by the LEDs in order to permit the replacement bulb to match the light output of the bulb being replaced.

### BACKGROUND OF THE INVENTION

An LED consists of a semiconductor junction, which emits light due to a current flowing through the junction. At first sight, it would seem that LEDs should make an excellent replacement for the traditional tungsten filament incandescent bulb. At equal power, they give far more light output than do incandescent bulbs, or, what is the same thing, they use much less power for equal light; and their operational life is orders of magnitude larger, namely, 10-100 thousand hours vs. 1-2 thousand hours.

However, LEDs have a number of drawbacks that have prevented them, so far, from being widely adopted as incandescent replacements. Among the chief of these is that, although LEDs require substantially less power for a given light output than do incandescent bulbs, it still takes many watts to generate adequate light for illumination. Whereas the tungsten filament in an incandescent bulb operates at a temperature of approximately 3000K, an LED, being a semiconductor, cannot be allowed to get hotter than approximately 120° C. The LED thus has a substantial heat problem: If operated in vacuum like an incandescent, or even in air, it would rapidly get too hot and fail. This has limited available LED bulbs to very low power (<approximately 3W), producing insufficient illumination for incandescent replacements.

One possible solution to this problem is to use a large metallic heatsink, attached to the LEDs. This heatsink would then extend out away from the bulb, removing the heat from the LEDs. This solution is undesirable, because of the common perception that customers will not use a bulb that is shaped radically differently from the traditional shaped incandescent bulb; and also from the consideration that the heatsink may make it impossible for the bulb to fit in to pre-existing fixtures.

More recently, a means for cooling LEDs in light bulbs have had the LEDs immersed in a fluid, a gel or a plastic (PCT/US07/10470 and PCT/US07/10469). The fluid, gel or plastic provides a high thermal conductivity path from the LED heat sources to the bulb's surface and the ambient.

In some cases, however, the thermal conductivity of the fluid, gel or plastic may still not be high enough to maintain the LEDs at their desirable operating temperature. This is true especially when using individual high-power LEDs as opposed to using many low-power LEDs. For these applications, then, it would be desirable to find a material that had even higher thermal conductivity or could be combined with these materials to achieve higher thermal conductivity, but that at the same time maintained the desirable characteristics of the fluid, gel or plastic, that is, low optical loss, and potentially electrical insulation.

### SUMMARY OF THE INVENTION

This invention has the object of developing a light emitting apparatus utilizing light emitting diodes (LEDs), such that the above-described primary problem is effectively solved. It aims at providing a replacement bulb for incandescent lighting having a plurality of LEDs with a light output equal in intensity to that of an incandescent bulb, and whose dissipated power may be effectively removed from the LEDs in such a way that their maximum rated temperature is not exceeded. The apparatus includes a bulb-shaped shell or body, formed of glass. The shell or body may be transparent, or may contain materials dispersed in or on it to disperse the light, making it appear not to have point sources of light, and may also contain materials dispersed in or on it to change the bluish color of the LED light to more yellowish color, more closely resembling the light from traditional incandescent bulbs.

The shell or body is preferably hollow inside having a cylindrical or tubular inner hollow cavity (or hollow portion). The hollow portion has the LEDs and their interconnecting means installed into it, and the remaining hollow portion filled with a thermally conductive fluid, gel or plastic, such as water or a hydrogel. This fluid, gel or plastic acts as the means to transfer the heat power generated by the LEDs to the glass, and from the glass to the shell, where it may be removed by radiation and convection, as in a traditional incandescent bulb. The fluid, gel or plastic may be transparent, or may contain materials dispersed in it to disperse the light, making it appear not to have point sources of light, and may also contain materials dispersed in it to change the bluish color of the LED light to more yellowish color, more closely resembling the light from traditional incandescent bulbs. The fluid, gel or plastic is preferably electrically insulating.

LEDs are installed in the fluid, gel or plastic in such a way as to prevent them from being shorted. If the fluid, gel or plastic is electrically insulating, no special measures need to be taken. If the fluid, gel or plastic is not electrically insulating, the electrically conductive portions of the LEDs may be electrically insulated to prevent shorting.

With the LEDs installed in the fluid, gel or plastic, the shell is sealed with a watertight seal, such as a plastic. Electrical contacts for powering the LEDs are brought out through the seal before the sealing is accomplished. These leads are connected to the power source for the LEDs, which will typically be included inside the remainder of the bulb. The power source is preferentially designed to be compatible with pre-existing designs, so that the bulb may directly replace traditional bulbs without requiring any change in the pre-existing fixture.

According to the present invention, an LED replacement bulb for incandescent lighting is constructed out of glass, with an interface material for heat transfer and mechanical buffering surrounding the LEDs inside the glass bulb.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a glass LED bulb having a hollow cavity, wherein the LEDs are mounted in a fluid, gel or plastic within the hollow cavity.

FIG. 2 is a plan view of a plurality of LEDs within the hollow cavity of the glass bulb as shown in FIG. 1.

### DESCRIPTION OF THE PREFERRED EMBODIMENT

Reference will now be made in detail to the present preferred embodiments of the invention, examples of which are illustrated in the accompanying drawings. Wherever possible, the same reference numbers are used in the drawings and the description to refer to the same or like parts.

According to the design characteristics, a detailed description of the preferred embodiment is given below.

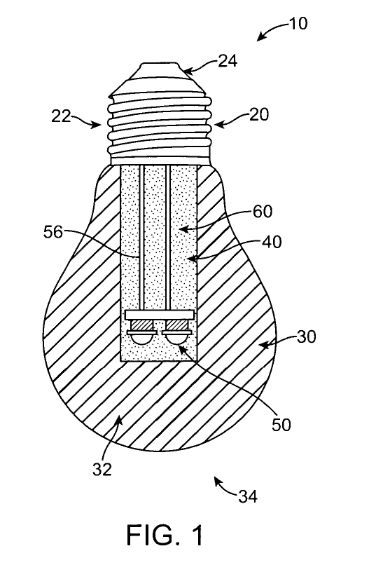

FIG. 1 is a cross-sectional view of a glass LED replacement bulb 10 comprised of a glass bulb 30 having at least one LED 50 mounted in a hollow portion 40 (or cavity) of the glass bulb 30. In accordance with a preferred embodiment, the hollow portion or cavity 40 contains a fluid, plastic or gel material 60. As shown in FIG. 1, the glass LED replacement bulb 10 includes a screw-in base 20, a glass bulb (or body) 30, at least one hollow portion or cavity 40 containing a thermally conductive fluid, plastic or gel material 60, and at least one LED 50.

The screw-in base 20 includes a series of screw threads 22 and a base pin 24. The screw-in base 20 is configured to fit within and make electrical contact with a standard electrical socket. The electrical socket is preferably dimensioned to receive an incandescent or other standard light bulb as known in the art. However, it can be appreciated that the screw-in base 20 can be modified to fit within any electrical socket, which is configured to receive an incandescent bulb. The screw-in base 20 makes electrical contact with the AC power in a socket through its screw threads 20 and its base pin 24. Inside the screw-in base 20 is a power supply (not shown) that converts the AC power to a form suitable for driving the at least one LED 50.

In accordance with one embodiment, the LED replacement bulb 10 includes a glass bulb 30 comprised of a bulb-shaped body 32. The bulb-shaped body 32 is preferably formed of glass with a constant or variable thickness, which extends toward the tip of the bulb 30. The tip portion 34 of the bulb 10 is fully comprised of glass or a glass-like material. The bulb-shaped body 32 may be transparent, or may contain materials dispersed in or on it to disperse the light, making it appear not to have point sources of light, and may also contain materials dispersed in or on it to change the bluish color of the LED light to more yellowish color, more closely resembling the light from traditional incandescent bulbs.

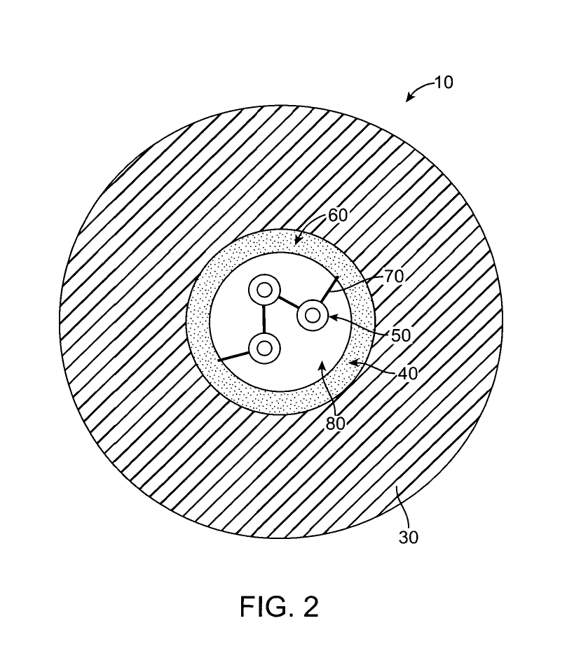

As shown in FIG. 1, the bulb-shaped body 32 of the glass bulb 30 contains at least one hollow portion 40, which preferably is of uniform cross-section down the length of the glass bulb 30, terminating at some depth, preferably at or above the half-way point of the glass bulb 30. However, it can be appreciated that in accordance with another embodiment, the at least one hollow portion 40 can include a plurality of hollow portions 40 having interconnections between each of the plurality of hollow portions. The hollow portion 40 is preferably made of such a size as to permit the printed circuit board 80 (FIG. 2) to be lowered into the hollow portion 40 with minimum excess space. In addition, the electrical interconnections 70 (FIG. 2) can be made on a printed circuit board or other suitable material, or can be made through the interconnections 40 between the plurality of hollow portions.

The hollow portion 40 contains the at least one LED 50 and the connecting wires 56 to the power source (not shown) within the base 20 of the bulb 10. The hollow portion 40 is filled, either completely or partially, and more preferably partially filled to approximately 90% of the total volume of the hollow portion 40, with a fluid, gel or plastic material 60, which functions as a low thermal-resistance thermal conductor for the heat dissipated by the LED or LEDs 50 to the glass bulb 30. It can be appreciated that the fluid, gel or plastic material 60 can be optically transparent, and/or an electrically insulating. In accordance with one embodiment, the fluid material 60 preferably includes a means to gel when exposed to air. It can be appreciated that in order to prevent leaks, the glass bulb 30 entirely encases the gel, fluid or plastic-filled hollow portion or cavity 40 with the exception of the portion of the hollow portion or cavity 40, which is attached to the base 20. The hollow portion of cavity 40 is preferably sealed, either with the glass of the glass bulb 30 or other material.

As shown in FIG. 1, the at least one LED 50 is connected by wires 56 to the power supply. The connecting wires 56 may be stiff enough to function as support for the at least one LED 50, and also for the interconnects 70 between the LEDs 50 when there are multiple devices. The glass bulb 30 also encases at least the light-emitting portion of the at least one LED 50, with the connecting wires 56 coming out through the glass bulb 30 through a sealed connection to the power supply.

FIG. 2 is a plan view of the at least one LED 50 mounted on a printed circuit board 80 within the hollow cavity 40. As shown in FIG. 2, the plurality of LEDs 50 are preferably mounted to a printed circuit board 80 and include interconnects 70 between the plurality of LEDs 50. In accordance with one embodiment, the interconnects 70 can be traces on the PCB (printed circuit board) 80.

The LED or LEDs 50 are comprised of two parts, the connecting wires 56 that connect them to the power supply, and the LED or LEDs 50 themselves. The connecting wires 56 are stiff enough to function as support for the LED or LEDs 50. In another embodiment, the connecting wires 56 may also form the interconnects between the LEDs 50 when there are multiple devices.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An LED bulb comprising:
a solid body, the body having at least one hollow portion formed therein;
at least one LED contained within the at least one hollow portion; and
a thermally conductive material within the at least one hollow portion,
wherein the thermally conductive material is configured to transfer heat from the at least one LED to the body.

2. An LED bulb as set forth in claim 1, wherein the body has a bulb-shape.

3. An LED bulb as set forth in claim 1, wherein the body has an incandescent bulb-shape.

4. An LED bulb as set forth in claim 1, wherein the thermally conductive material is a fluid, a gel, or a plastic.

5. An LED bulb as set forth in claim 4, wherein the fluid, gel, or plastic is optically transparent.

6. An LED bulb as set forth in claim 4, wherein the fluid, gel, or plastic contains means, or is itself the means, to disperse and/or to color shift the light.

7. An LED bulb as set forth in claim 4, wherein the fluid, gel, or plastic is electrically insulating.

8. An LED bulb as set forth in claim 4, wherein the thermally conductive material is a fluid that contains a means to gel when exposed to air.

9. An LED bulb as set forth in claim 4, wherein the fluid, gel, or plastic is hydrated polyacrylimide.

10. An LED bulb as set forth in claim 4, wherein the fluid, gel, or plastic provides mechanical relief for the body.

11. An LED bulb as set forth in claim 1, wherein the at least one hollow portion comprises a plurality of hollow portions having interconnections.

12. An LED bulb as set forth in claim 11, wherein the interconnections are used to interconnect the at least one LED.

13. An LED bulb as set forth in claim 1, further comprising a power source for the at least one LED, which is included in the bulb.

14. An LED bulb as set forth in claim 13, wherein the power source for the at least one LED is compatible with pre-existing power sources, permitting the bulb to be used in pre-existing fixtures.

15. An LED bulb as set forth in claim 1, wherein the bulb-shaped body contains means to disperse and/or means to color shift the light.

16. An LED bulb as set forth in claim 15, wherein the means to disperse the light is bubbles in the body.

17. An LED bulb as set forth in claim 15, wherein the means to disperse the light is a collection of Mie scatterers in the body.

18. An LED bulb as set forth in claim 15, wherein the means to color shift the light is a dye in the body.

19. An LED bulb as set forth in claim 15, wherein the means to color shift the light is a collection of Rayleigh scatterers in the body.

20. An LED bulb as set forth in claim 1, wherein the at least one LED includes a plurality of LEDs, and wherein interconnections between the LEDs are made on a printed circuit board.

21. An LED bulb comprising:
a solid body, the body having a plurality of hollow portions formed therein;
at least one LED contained within the plurality of hollow portions; and
a thermally conductive material within the plurality of hollow portions.

22. An LED bulb as set forth in claim 21, wherein the body has a bulb-shape.

23. An LED bulb as set forth in claim 21, wherein the body has an incandescent bulb-shape.

24. An LED bulb as set forth in claim 21, wherein the thermally conductive material is a fluid, a gel, or a plastic.

25. An LED bulb as set forth in claim 24, wherein the fluid, gel, or plastic is optically transparent.

26. An LED bulb as set forth in claim 24, wherein the fluid, gel, or plastic contains means, or is itself the means, to disperse and/or to color shift the light.

27. An LED bulb as set forth in claim 24, wherein the fluid, gel, or plastic is electrically insulating.

28. An LED bulb as set forth in claim 24, wherein the thermally conductive material is a fluid that contains a means to gel when exposed to air.

29. An LED bulb as set forth in claim 24, wherein the fluid, gel, or plastic is hydrated polyacrylimide.

30. An LED bulb as set forth in claim 24, wherein the fluid, gel, or plastic provides mechanical relief for the body.

31. An LED bulb as set forth in claim 21, wherein the plurality of hollow portions include interconnections.

32. An LED bulb as set forth in claim 31, wherein the interconnections are used to interconnect the at least one LED.

33. An LED bulb as set forth in claim 21, further comprising a power source for the at least one LED, which is included in the bulb.

34. An LED bulb as set forth in claim 33, wherein the power source for the at least one LED is compatible with pre-existing power sources, permitting the bulb to be used in pre-existing fixtures.

35. An LED bulb as set forth in claim 21, wherein the bulb-shaped body contains means to disperse and/or means to color shift the light.

36. An LED bulb as set forth in claim 35, wherein the means to disperse the light is bubbles in the body.

37. An LED bulb as set forth in claim 35, wherein the means to disperse the light is a collection of Mie scatterers in the body.

38. An LED bulb as set forth in claim 35, wherein the means to color shift the light is a dye in the body.

39. An LED bulb as set forth in claim 35, wherein the means to color shift the light is a collection of Rayleigh scatterers in the body.

40. An LED bulb as set forth in claim 21, wherein the at least one LED includes a plurality of LEDs, and wherein interconnections between the LEDs are made on a printed circuit board.
